(19) United States
(12) Patent Application Publication
(10) Pub. No.: US 2016/0364247 A1
(43) Pub. Date: Dec. 15, 2016

(54) OPERATION METHOD OF COMMUNICATION NODE IN AUTOMOTIVE NETWORK

(71) Applicant: Hyundai Motor Company, Seoul (KR)

(72) Inventors: Jin Hwa Yun, Seoul (KR); Kang Woon Seo, Seoul (KR); Dong Ok Kim, Goyang (KR)

(21) Appl. No.: 15/176,429

(22) Filed: Jun. 8, 2016

(30) Foreign Application Priority Data
Jun. 11, 2015 (KR) 10-2015-0082635

(51) Int. Cl. G06F 9/44; B60R 16/023; H04L 12/40

(52) U.S. Cl. CPC G06F 9/4418; H04L 12/40; G06F 9/4406; G06F 9/4416; B60R 16/023; H04L 2012/40215; H04L 2012/40241; H04L 2012/40273

(57) ABSTRACT

An operation method of a communication node, including a physical (PHY) layer block and a controller includes: receiving, at the controller, a wakeup signal for waking up the controller from the PHY layer block; performing, at the controller, a parting booting operation for a portion of an operating system (OS) which is required to receive data transmitted by the PHY layer block; receiving, by the controller, data transmitted by the PHY layer block; and storing, at the controller, the received data in a buffer activated according to the partial booting operation.

### CROSS-REFERENCE TO RELATED APPLICATIONS

This application claims the benefit of and priority to Korean Patent Application No. 10-2015-0082635 filed on Jun. 11, 2015 in the Korean Intellectual Property Office (KIPO), the entire contents of which are hereby incorporated by reference.

### BACKGROUND

1. Technical Field

The present disclosure relates generally to communications between nodes in automotive network, and more particularly, to a technique for preventing data loss in a receiving communication node when data communications are performed between communication nodes.

2. Related Art

Along with the rapid digitalization of vehicle parts, the number and variety of electronic devices installed within a vehicle have been increasing significantly. Electronic devices may currently be used in a power train control system, a body control system, a chassis control system, an automotive network, a multimedia system, and the like. The power train control system may include an engine control system, an automatic transmission control system, etc. The body control system may include a body electronic equipment control system, a convenience apparatus control system, a lamp control system, etc. The chassis control system may include a steering apparatus control system, a brake control system, a suspension control system, etc.

Meanwhile, an automotive network may include a controller area network (CAN), a FlexRay-based network, a media oriented system transport (MOST)-based network, etc. The multimedia system may include a navigation apparatus system, a telematics system, an infotainment system, etc.

Such systems and electronic devices constituting each of the systems are connected via the automotive network, which supports functions of the electronic devices. For instance, the CAN may support a transmission rate of up to 1 Mbps and may support auto retransmission of colliding messages, error detection-based on a cyclic redundancy check (CRC), etc. The FlexRay-based network may support a transmission rate of up to 10 Mbps and may support simultaneous transmission of data through two channels, synchronous data transmission, etc. The MOST-based network is a communication network for high-quality multimedia, which may support a transmission rate of up to 150 Mbps.

Meanwhile, the telematics system, the infotainment system, as well as enhanced safety systems of a vehicle require high transmission rates and system expandability. However, the CAN, FlexRay-based network, or the like may not sufficiently support such requirements. The MOST-based network may support a higher transmission rate than the CAN and the FlexRay-based network. However, costs increase to apply the MOST-based network to all automotive networks. Due to these limitations, an Ethernet based network may be considered as an automotive network. The Ethernet-based network may support bi-directional communication through one pair of windings and may support a transmission rate of up to 10 Gbps.

Each communication node constituting the automotive network may include a physical (PHY) layer block configured to perform data or control signal communications with external nodes and a controller configured to perform functions of the communication node. In order to reduce power consumption of the communication node, in some cases only the PHY layer block is activated, and the controller rapidly transitions from an inactivation mode to an activation mode according to a signal received from an external node. The controller may start an operating system (OS) booting operation when the PHY layer block receives the data or control signal from the external node. Therefore, the data having been received at the PHY layer block before the booting operation of the OS is completed may be lost since the data are received during an inactive mode of the controller.

### SUMMARY

Accordingly, embodiments of the present disclosure are provided to substantially obviate one or more problems due to limitations and disadvantages of the related art. Embodiments of the present disclosure provide operation methods of a communication node, in which a partial booting for a portion of an operating system which is used for data reception is preferentially performed by a controller of a receiving communication node such that data can be stored in a buffer of the receiving communication node.

In accordance with embodiments of the present disclosure, an operation method of a communication node, which includes a physical (PHY) layer block and a controller includes: receiving, by the controller, a wakeup signal for waking up the controller from the PHY layer block; performing, by the controller, a partial booting operation for a first portion of an operating system (OS) which is required to receive data transmitted by the PHY layer block; receiving, by the controller, data transmitted by the PHY layer block; and storing, by the controller, the received data in a buffer activated according to the partial booting operation.

The controller may receive the wakeup signal via at least one of: a media independent interface (MII), a reduced MII (RMII), a gigabit MII (GMII), a reduced GMII (RGMII), a serial GMII (SGMII), and a 10 GMII (XGMII).

The first portion of the OS may include at least one of a network management kernel and a memory management kernel.

The buffer that is activated according to the partial booting operation may be a reception (RX) buffer.

The method may further comprise transmitting, by the controller, configuration information for the PHY layer block to the PHY layer block.

The method may further comprise transferring, by the controller, the data stored in the buffer to a main memory of the controller.

Also, the transferring of the data stored in the buffer to the main memory of the controller may comprise performing, by the controller, a remaining booting operation for a second portion of the OS; and transferring, by the controller, the data stored in the buffer to the main memory of the controller after completion of the remaining booting operation.

Also, the controller may perform the remaining booting operation and store the data in the buffer in a parallel processing manner.

The communication node may be connected to an automotive network.

Furthermore, in accordance with the embodiments of the present disclosure, an operation method of a communication node, which includes a physical (PHY) layer block and a controller includes: receiving, by the controller, a wakeup signal for waking up the controller from the PHY layer block; performing, by a sub-core of the controller, a partial booting operation for a first portion of an operating system (OS) which is required to receive data transmitted by the PHY layer block; receiving, by the sub-core of the controller, data transmitted by the PHY layer block; and storing, by the sub-core of the controller, the received data in a buffer activated according to the partial booting operation.

The buffer that is activated according to the partial booting operation may be a reception (RX) buffer.

The sub-core of the controller may transfer the data stored in the buffer to a main memory of the controller.

Also, the transferring of the data stored in the buffer to the main memory of the controller may comprise performing, by a core of the controller, a remaining booting operation for a second portion of the OS; and transferring, by the core of the controller, the data stored in the buffer to the main memory of the controller after completion of the remaining booting operation.

Also, the remaining booting operation and the storing of the data in the buffer may be performed by the core of the controller and the sub-core of the controller, respectively, in a parallel processing manner.

The communication node may be connected to an automotive network.

Furthermore, in accordance with embodiments of the present disclosure, an operation method of a communication node, which includes a physical (PHY) layer block and a controller includes: receiving, by the PHY layer block, a signal transmitted by a counterpart communication node; transmitting, by the PHY layer block, a wakeup signal for waking up the controller to the controller; receiving, by the PHY layer block, configuration information for the PHY layer block from the controller; configuring, by the PHY layer block, a PHY layer using the received configuration information; and transmitting, by the PHY layer block, data included in the received signal to the controller.

The communication node may be connected to an automotive network.

Furthermore, in accordance with embodiments of the present disclosure, a controller of a communication node, which includes a physical (PHY) layer block includes: a controller interface part receiving a wakeup signal for waking up the controller from the PHY layer block and data transmitted by the PHY layer block; a core performing a partial booting operation for a first portion of an operating system (OS) which is required to receive the data transmitted by the PHY layer block; a buffer storing the received data transmitted by the PHY layer block; and a memory control logic controlling the buffer to store the received data.

The core may control the controller interface part to transmit configuration information to the PHY layer block and control the buffer to store the data received from the PHY layer block.

The core may perform a remaining booting operation for a second portion of the OS and transfer the data stored in the buffer to a main memory of the controller after completion of the remaining booting operation.

Also, the core may perform the remaining booting operation and store the data in the buffer in a parallel processing manner.

Furthermore, in accordance with embodiments of the present disclosure, a controller of a communication node, which includes a physical (PHY) layer block includes: a controller interface part receiving a wakeup signal for waking up the controller from the PHY layer block and data transmitted by the PHY layer block; a sub-core performing a partial booting operation for a first portion of an operating system (OS) which is required to receive the data transmitted by the PHY layer block; a buffer storing the received data transmitted by the PHY layer block; a memory control logic controlling the buffer to store the data; and a core performing a remaining booting operation for a second portion of the OS and transferring the data stored in the buffer to a main memory of the controller after completion of the remaining booting operation.

The remaining booting operation and the storing of the data in the buffer may be performed by the core and the sub-core, respectively, in a parallel processing manner.

Furthermore, in accordance with embodiments of the present disclosure, a physical (PHY) layer block of a communication node, which includes a controller includes: a PHY layer interface part receiving a signal transmitted by a counterpart communication node, and receiving configuration information for the PHY layer block from the controller; a PHY layer processor causing a wakeup signal for waking up the controller to be transmitted to the controller and configuring the PHY layer block using the configuration information; and a PHY layer buffer storing data included in the signal received from the counterpart communication node.

According to embodiments of the present disclosure, when data communications are performed between communication nodes in an automotive network, data loss can be prevented by preferentially performing a partial booting of a portion of an operating system which is used for data reception in a receiving communication node.

### BRIEF DESCRIPTION OF DRAWINGS

Embodiments of the present disclosure will become more apparent by describing in detail embodiments of the present disclosure with reference to the accompanying drawings, in which:

FIG. 1 is a diagram showing an automotive network topology according to embodiments of the present disclosure;

FIG. 2 is a diagram showing a communication node constituting an automotive network according to embodiments of the present disclosure;

FIG. 3 is a sequence chart of embodiments illustrating network connection relations of communication nodes according to the present disclosure;

FIG. 4 is a flow chart to explain an operation method of a communication node in FIG. 3 according to embodiments of the present disclosure;

FIG. 5 is a conceptual diagram of a structure of a kernel to explain the partial booting operation of the OS;

FIG. 6 is a block diagram to explain an activation of a reception buffer according to embodiments of the present disclosure;

FIG. 7 is a flow chart to explain a step of transferring data stored in a buffer to a main memory according to embodiments of the present disclosure;

FIG. 8 is a flow chart to explain an additional operation method of a communication node of FIG. 3 according to embodiments of the present disclosure;

FIG. 9 is a block diagram to explain activation of a RX buffer for data reception according to embodiments of the present disclosure;

FIG. 10 is a flow chart to explain an additional operation method of a communication node according to embodiments of the present disclosure;

FIG. 11 is a timing diagram to explain an operation method of a communication node according to embodiments of the present disclosure;

FIG. 12 is a block diagram to explain a controller according to embodiments of the present disclosure;

FIG. 13 is a block diagram to explain an additional controller according to embodiments of the present disclosure; and

FIG. 14 is a block diagram to explain a PHY layer block according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Although exemplary embodiment is described as using a plurality of units to perform the exemplary process, it is understood that the exemplary processes may also be performed by one or plurality of modules. Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, control logic of the present disclosure may be embodied as non-transitory computer readable media on a computer readable medium containing executable program instructions executed by a processor, controller, or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several embodiments, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

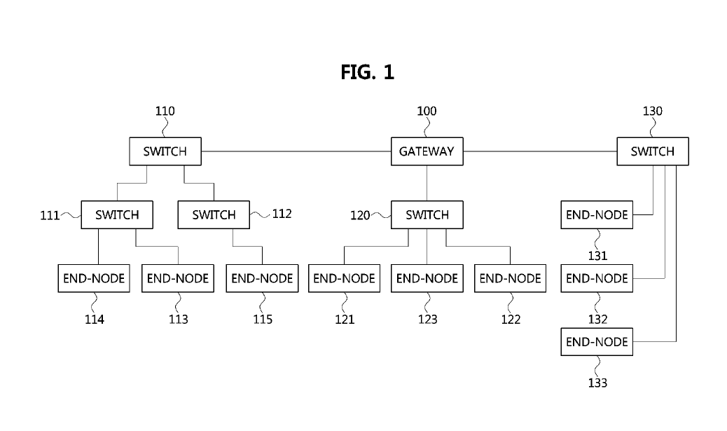

FIG. 1 is a diagram showing an automotive network topology according to embodiments of the present disclosure.

As shown in FIG. 1, a communication node may include a gateway, a switch (or bridge), or an end node. The gateway 100 may be connected with at least one switch 110, 111, 112, 120, and 130 and may be configured to connect different networks. For example, the gateway 100 may connect a switch that supports a controller area network (CAN) (e.g., FlexRay, media oriented system transport (MOST), or local interconnect network (LIN)) protocol and a switch that supports an Ethernet protocol. The switches 110, 111, 112, 120, and 130 may be connected with at least one end nodes 113, 114, 115, 121, 122, 123, 131, 132, and 133. The switches 110, 111, 112, 120, and 130 may interconnect and operate the end nodes 113, 114, 115, 121, 122, 123, 131, 132, and 133.

The end nodes 113, 114, 115, 121, 122, 123, 131, 132, and 133 may include an electronic control unit (ECU) configured to operate various types of devices mounted within a vehicle. For example, the end nodes 113, 114, 115, 121, 122, 123, 131, 132, and 133 may include an ECU configured to operate an infotainment device (e.g., a display device, a navigation device, an around view monitoring device, etc.).

Communication nodes (e.g., a gateway, a switch, an end node, or the like) included in an automotive network may be connected in a star topology, bus topology, ring topology, tree topology, mesh topology, etc. In addition, the communication nodes of the automotive network may support a CAN protocol, FlexRay protocol, MOST protocol, LIN protocol, or Ethernet protocol. Exemplary embodiments of the present disclosure may be applied to the above-described network topology. The network topology to which exemplary embodiments of the present disclosure are to be applied is not limited thereto and may be configured in various ways.

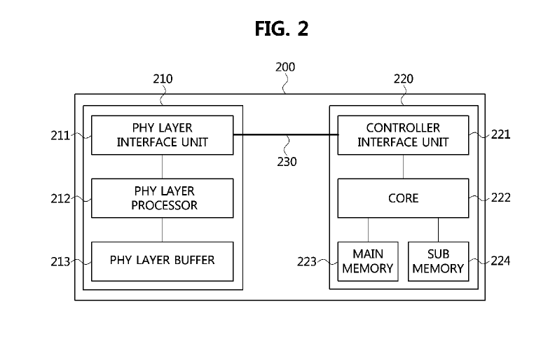

FIG. 2 is a diagram showing a communication node constituting an automotive network according to embodiments of the present disclosure. Notably, the various methods discussed herein below may be executed by a controller having a processor and a memory, as explained above.

As shown in FIG. 2, a communication node 200 of a network may include a PHY layer block 210 and a controller 220. In particular, the controller 220 may be implemented to include a medium access control (MAC) layer. A PHY layer block 210 may be configured to receive or transmit signals from or to another communication node. The controller 220 may be configured to operate the PHY layer block 210 and perform various functions (e.g., an infotainment function). The PHY layer block 210 and the controller 220 may be implemented as one system on chip (SoC) or alternatively, may be implemented as separate chips.

Further, the PHY layer block 210 and the controller 220 may be connected via a media independent interface (MII) 230. The MII 230 may include an interface defined in the IEEE 802.3 and may include a data interface and a management interface between the PHY layer block 210 and the controller 220. One of a reduced MII (RMII), a gigabit MII (GMII), a reduced GMII (RGMII), a serial GMII (SGMII), a 10 GMII (XGMII) may be used instead of the MII 230. A data interface may include a transmission channel and a reception channel, each of which may have an independent clock, data, and a control signal. The management interface may include a two-signal interface, one signal for the clock and one signal for the data.

Particularly, the PHY layer block 210 may include a PHY layer interface part 211, a PHY layer processor 212, and a PHY layer buffer 213. The configuration of the PHY layer block 210 is not limited thereto, and the PHY layer block 210 may be configured in various ways. The PHY layer interface part 211 may be configured to transmit a signal received from the controller 220 to the PHY layer processor 212 and transmit a signal received from the PHY layer processor 212 to the controller 220. The PHY layer processor 212 may be configured to execute operations of the PHY layer interface part 211 and the PHY layer buffer 213. The PHY layer processor 212 may be configured to modulate a signal to be transmitted or demodulate a received signal. The PHY layer processor 212 may be configured to operate the PHY layer buffer 213 to input or output a signal. The PHY layer buffer 213 may be configured to store the received signal and output the stored signal based on a request from the PHY layer processor 212.

The controller 220 may be configured to monitor and operate the PHY layer block 210 using the Mil 230. The controller 220 may include a controller interface 221, a core 222, a main memory 223, and a sub memory 224. The configuration of the controller 220 is not limited thereto, and the controller 220 may be configured in various ways. The controller interface part 221 may be configured to receive a signal from the PHY layer block 210 (e.g., the PHY layer interface part 211) or an upper layer (not shown), transmit the received signal to the core 222, and transmit the signal received from the core 222 to the PHY layer block 210 or upper layer. The core 222 may further include an independent memory control logic or an integrated memory control logic for operating the controller interface part 221, the main memory 223, and the sub memory 224. The memory control logic may be implemented to be included in the main memory 223 and the sub memory 224 or may be implemented to be included in the core 222.

Furthermore, each of the main memory 223 and the sub memory 224 may be configured to store a signal processed by the core 222 and may be configured to output the stored signal based on a request from the core 222. The main memory 223 may be a volatile memory (e.g., a random access memory (RAM)) configured to temporarily store data required for the operation of the core 222. The sub memory 224 may be a non-volatile memory in which operating system codes (e.g., kernel and device drivers) and an application program code for performing a function of the controller 220 may be stored. A flash memory having a high processing speed or a hard disc drive (HDD) or a compact disc-read only memory (CD-ROM) for large capacity data storage may be used as the non-volatile memory. Typically, the core 222 may include a logic circuit having at least one processing core. A core of an Advanced RISC Machines (ARM) family or a core of an Atom family may be used as the core 222.

A method performed by a communication node and a corresponding counterpart communication node, which belong to an automotive network, will be described below. Although a method (e.g., signal transmission or reception) performed by a first communication node will be described below, a second communication node that corresponds thereto may perform a method (e.g., signal reception or transmission) corresponding to the method performed by the first communication node. In other words, when an operation of the first communication node is described, the second communication node corresponding thereto may be configured to perform an operation that corresponds to the operation of the first communication node. Additionally, when an operation of the second communication node is described, the first communication node may be configured to perform an operation that corresponds to an operation of a switch.

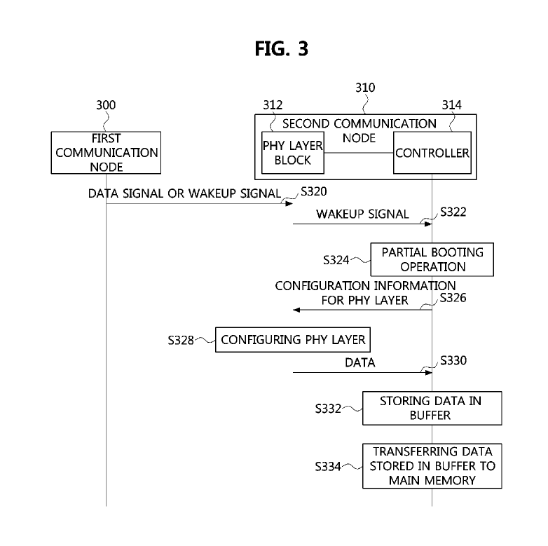

FIG. 3 is a sequence chart of embodiments illustrating network connection relations of communication nodes according to the present disclosure.

As shown in FIG. 3, a first communication node 300 and a second communication node 310 may be connected through a network. For example, the first communication node 300 and the second communication node 310 may communicate with each other by using a CAN protocol, a FlexRay protocol, a MOST protocol, a LIN protocol, or an Ethernet protocol. Also, each of the first communication node 300 and the second communication node 310 may include a PHY layer block 312 and a controller 314. Here, the PHY layer block 312 and the controller 314 may be same as the PHY layer block 210 and the controller 220 which are explained referring to FIG. 2.

The first communication node 300 having data to be transmitted to the second communication node 310 may generate a signal including the data (hereinafter, “data signal”) or a signal for triggering wake-up of the second communication node 310 (hereinafter, “wakeup signal”). When a channel is idle, the first communication node 300 may transmit the data signal or the wakeup signal to the second communication node 310 (S320). When the wakeup signal is transmitted to the second communication node 310, the first communication node 300 may transmit the data signal to the second communication node 310 after a lapse of a predetermined time from a time point of the transmission of the wakeup signal.

The PHY layer block 312 of the second communication node 310 may perform an energy detection operation to determine whether a signal exists in a channel. The PHY layer block 312 may transmit the wakeup signal for triggering the wake-up of the controller 314 in the second communication node 310 to the controller 314 (S322).

According to reception of the wakeup signal, the controller 314 may start to perform a partial booting operation of an operating system (OS) for data reception from the PHY layer block 312 (S324). The partial booting operation of the OS may mean a booting operation of a portion of the OS which is related to the data reception, such as a portion of OS kernel and device drivers which are required to be activated for the data reception.

While performing the partial booting operation, the controller 314 may transmit configuration information for the PHY layer block 312 to the PHY layer block 312 (S326). The configuration information for the PHY layer block may be information for configuring operations of the PHY layer block 312 and interface between the PHY layer block 312 and the controller 314. Such the configuration information for the PHY layer block may be preset as default values in the PHY layer block 312, or may be generated and provided to the PHY layer block 312 by the controller 314.

Then, the PHY layer block 312 may perform configuration operations for the PHY layer block 312 by using the received configuration information (S328). After completion of the configuration operations, the PHY layer block 312 may transmit the data received from the first communication node 300 to the controller 314. According to the partial booting (i.e., partial activation) operation of the OS related to the data reception, the controller 314 may receive the data transmitted from the PHY layer block 312 (S330), and store the received data in the buffer activated by the partial activation operation (S332). Then, the controller 314 may transfer the data stored in the buffer to the main memory (S334). In this case, the buffer used in the step S332 may be a memory sector which is allocated in a specific area of the main memory. Therefore, in the case that the buffer is the memory sector in the main memory, since the received data are already stored in the buffer corresponding to the memory sector of the main memory, the step S334 may be omitted.

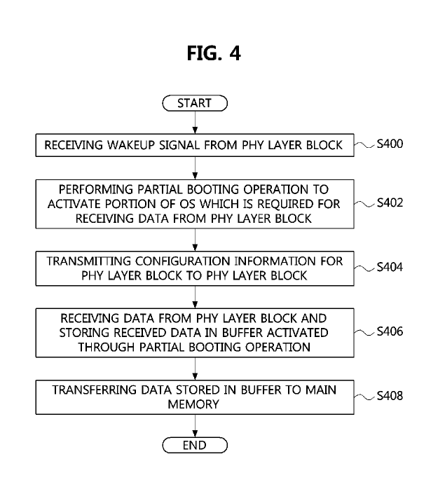

FIG. 4 is a flow chart to explain an operation method of a communication node in FIG. 3 according to embodiments of the present disclosure.

The controller constituting the communication node may receive a wakeup signal for waking up the controller from the PHY layer block (S400). Basically, the controller may operate in a doze mode, and transition from the doze mode (e.g., inactive mode) to an awake mode (e.g., active mode) if necessary. Since the wakeup signal is just a signal for waking up the controller, the controller may not store the received wakeup signal.

The controller may receive the wakeup signal from the PHY layer block. For this, the controller may be connected to the PHY layer block via a predetermined interface. Here, the predetermined interface may be MII, RMII, GMII, RGMII, SGMII, XGMII, for instance.

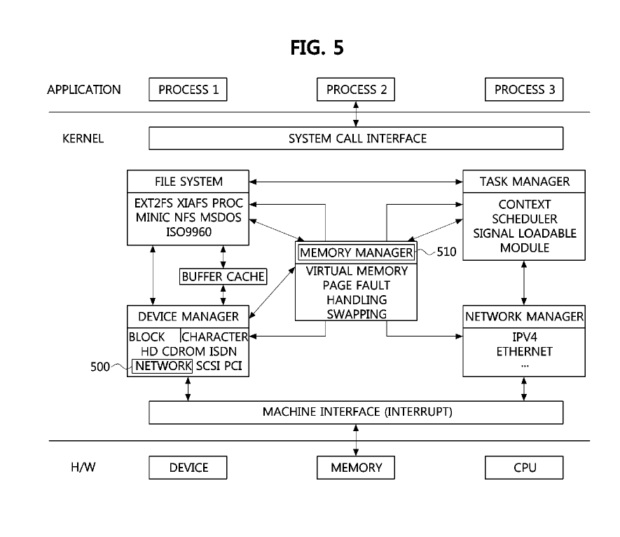

After the step S400, the controller may perform a partial booting operation of the OS in order to receive data transmitted from the PHY layer block (S402). FIG. 5 is a conceptual diagram of a structure of a kernel to explain the partial booting operation of the OS. As illustrated in FIG. 5, in the structure of the kernel, a device network management kernel (e.g., device manager) 500 and a memory management kernel (e.g., memory manager) 510 which correspond to a portion of the kernel which is used for data reception may be activated. Through the activation of the device network management kernel 500 and the memory management kernel 510, the controller may first activate a reception buffer (RX buffer) among buffers for interfacing with the PHY layer block. The RX buffer and a transmission buffer (TX buffer) may be constructed as separate modules or allocated to separate memory sectors in the main memory. Also, as illustrated in FIG. 2, the TX buffer and the RX buffer may be included in the controller interface part 221.

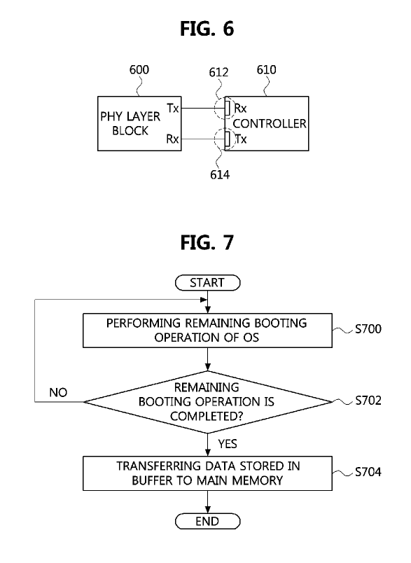

FIG. 6 is a block diagram to explain an activation of a reception buffer according to embodiments of the present disclosure. As illustrated in FIG. 6, the controller 610 may include a RX buffer 612 and a TX buffer 614. Here, the RX buffer 612 is a memory space for data reception which operates according to the booting of the OS. Also, the TX buffer 614 is a memory space for data transmission which operates according to the booting of the OS. Therefore, according to the partial booting operation of the OS, the controller 610 may preferentially activate the RX buffer 612 which exists as an independent module or is allocated to a specific memory sector of the main memory, before activation of the TX buffer 614.

After the step S402, the controller may transmit configuration information for the PHY layer block to the PHY layer block (S404). The configuration information for the PHY layer block may be information for operations of the PHY layer block and interface between the PHY layer block and the controller, and may be provided from the controller. However, such the configuration information for the PHY layer block may be preset as default values in the PHY layer block. In the case that the configuration information for the PHY layer block are preset as default values, the controller may not transmit such the configuration information to the PHY layer block. The controller may transmit the configuration information for the PHY layer block to the PHY layer block through an interface such as Mil, RMII, GMII, RGMII, SGMII, or XGMII.

After the step S404, the controller may receive data transmitted from the PHY layer block and store the data in the activated RX buffer (S406). Upon receiving the configuration information of the PHY layer block from the controller, the PHY layer block may configure its PHY layer using the configuration information. Then, the PHY layer block may transfer data received from a counterpart communication node to the controller. Accordingly, the controller may receive the data transferred from the PHY layer block, and store the received data in the activated buffer (e.g., the RX buffer 612 of FIG. 6). Here, the controller may perform the operation of storing the received data in the buffer and the remaining booting operation after the partial booting operation in a parallel processing manner. Here, the remaining booting operation after the partial booting operation may include all operations required for the booting operation of the OS after the partial booting operation. That is, the remaining booting operation may mean a booting operation for activating another portion of the OS except the portion activated through the partial booting operation.

After the step S406, the controller may transfer the data stored in the buffer to the main memory (S408). As the data are stored in the RX buffer activated according to the partial booting operation of the OS, the controller may transfer the stored data to the main memory sequentially. The controller may perform the operation of transferring the data to the main memory and the remaining booting operation in a parallel processing manner. That is, while performing the remaining booting operation, the data stored in the RX buffer may be transferred to the main memory. However, as described above, the RX buffer may be a memory sector allocated in a specific area of the main memory. In the case that the RX buffer corresponds to a specific memory sector of the main memory, since the received data are already stored in the memory sector in the main memory, the step of transferring the data to the main memory may be omitted.

Meanwhile, the controller may transfer the data to the main memory after completion of the remaining booting operation. FIG. 7 is a flow chart to explain a step of transferring data stored in a buffer to a main memory according to an exemplary embodiment of the present disclosure.

After the partial booting operation of the OS, the controller may perform the remaining booting operation (S700). As described above, the controller may perform the operation of storing data in the buffer and the remaining booting operation in a parallel manner.

After the step S700, the controller may determine whether the remaining booting operation is completed or not (S702).

In the step S702, if the remaining booting operation is completed, the controller may transfer the data stored in the buffer to the main memory (S704). In the remaining booting operation, the OS kernel for the booting operation may be loaded. Then, the initialization and setup process for the communication node may be completed by decompressing the OS kernel and performing the booting operation. Accordingly, the controller may perform operations by using the data stored in the main memory. However, as described above, in the case that the RX buffer corresponds to the memory sector of the main memory, the step of transferring the received data to the main memory may be omitted.

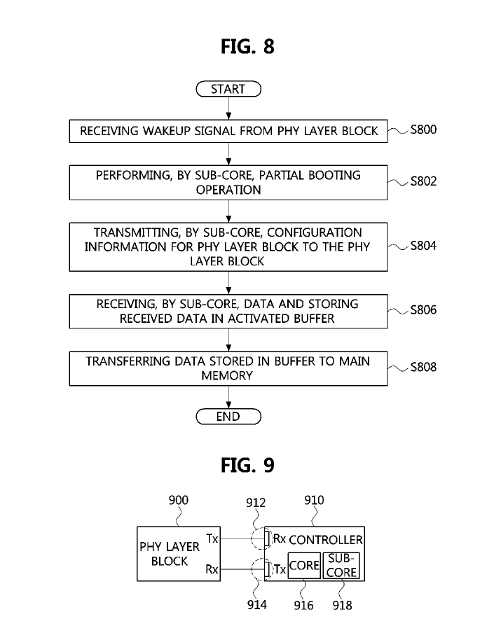

FIG. 8 is a flow chart to explain an additional operation method of a communication node of FIG. 3 according to embodiments of the present disclosure.

The controller constituting the communication node may receive a wakeup signal for waking up the controller from the PHY layer block (S800). Since the step S800 is equal or similar to the above-described step S400, redundant explanation on the step S800 is omitted.

After the step S800, among a core and a sub-core constituting the controller, the sub-core may perform a partial booting operation of an OS to receive data transmitted from the PHY layer block according to the wakeup signal (S802). As illustrated in FIG. 5, in the structure of the kernel, a device network management kernel (device manager) 500 and a memory management kernel (memory manager) 510 which correspond to a portion of the kernel which is used for data reception may be activated by the sub-core of the controller. Through the activation of the device network management kernel 500 and the memory management kernel 510, the sub-core of the controller may first activate a reception buffer (RX buffer) among buffers for interfacing with the PHY layer block.

FIG. 9 is a block diagram to explain activation of a RX buffer for data reception according to another exemplary embodiment of the present disclosure. As illustrated in FIG. 9, the controller 910 may include a RX buffer 912, a TX buffer 914, a core 916, and a sub-core 918. Here, the RX buffer 912 may exist as an independent module or be allocated to a predetermined memory sector of the main memory, and may be activated by the sub-core 918 of the controller before activation of the TX buffer 914 through the partial booting operation performed by the sub-core 918.

After the step S802, the sub-core may transmit configuration information for the PHY layer block to the PHY layer block (S804). The sub-core may transmit the configuration information to the PHY layer block via an interface such as MII, RMII, GMII, RGMII, SGMII, or XGMII.

After the step S804, the sub-core may receive data transmitted from the PHY layer block, and store the received data in the activated buffer (i.e., the RX buffer) (S806). The PHY layer block may configure its PHY layer by using the configuration information, and transfer data received from a counterpart communication node to the controller. Accordingly, the sub-core of the controller may receive the data transmitted from the PHY layer block, and store the data in the buffer according to the partial booting operation.

Meanwhile, the core of the controller may perform the remaining booting operation in response to the wakeup signal. The core may perform the remaining booting operation and the operation of storing the data in the buffer in a parallel manner.

After the step S806, the core or sub-core may transfer the date stored in the buffer to the main memory (S808). If the data are stored in the RX buffer activated according to the partial booting operation, the sub-core may transfer the stored data to the main memory sequentially. The operation of transferring the data to the main memory which is performed by the sub-core and the remaining booting operation performed by the core may be performed in a parallel manner. That is, while performing the remaining booting operation, the data stored in the RX buffer may be transferred to the main memory.

Alternatively, the core may transfer the data to the main memory after completion of the remaining booting operation. The core may determine whether the remaining booting operation is completed or not. If the remaining booting operation is completed, the role of the sub-core may be not further necessary. Therefore, control functions of the sub-core may be transferred to the core. That is, after the remaining booting operation is completed, the control function of the sub-core may be transferred to the core, and the core may transfer the data stored in the buffer to the main memory. Accordingly, the core may perform operations by using the data stored in the main memory. However, in the case that RX buffer corresponds to a memory sector of the main memory, since the received data are already stored in the memory sector of the main memory, the step of transferring the received data to the main memory may be omitted.

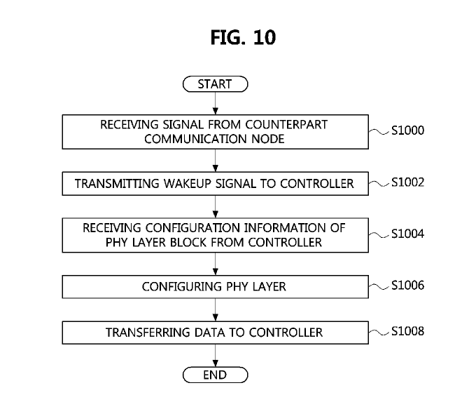

FIG. 10 is a flow chart to explain an additional operation method of a communication node according to embodiments of the present disclosure.

The PHY layer block constituting the communication node may receive a signal transmitted by a counterpart communication node (S1000). The PHY layer block may always operate in an awake mode. The PHY layer block may identify whether a signal exists in a channel through an energy detection operation. For example, when a signal stronger than a threshold is detected in a channel through the energy detection operation, the PHY layer block may determine that the signal exists in the channel. The signal may include both of a signal for waking up (e.g., wakeup signal) and a signal for data (e.g., data signal), or include only the wakeup signal.

After the step S1000, upon receiving the signal, the PHY layer block may transmit a wakeup signal for waking up the controller to the controller (S1002). The PHY layer block constituting the communication node may transmit the wakeup signal for the controller, as another component of the communication node, to the controller. Since the wakeup signal is a signal for triggering wake-up of the controller, the controller may not store the wakeup signal. The PHY layer block may transmit the wakeup signal to the controller via an interface such as Mil, RMII, GMII, RGMII, SGMII, or XGMII.

After the step S1002, the PHY layer block may receive configuration information for the PHY layer block from the controller (S1004). The configuration information which is transmitted to the PHY layer block may include configuration information for operations of the PHY layer block and interface between the PHY layer block and the controller. However, if the PHY layer block already has the configuration information for the PHY layer block as default values, the PHY layer block may not receive such the configuration information from the controller.

After the step S1004, the PHY layer block may configure its PHY layer by using the configuration information (S1006). The PHY layer block may perform configuration for the operations of the PHY layer block and the interface between the controller and the PHY layer block.

After the step S1006, the PHY layer block may transfer data to the controller (S1008). Through the above-described configuration of the PHY layer block, the PHY layer block may become able to transmit data to the controller. Therefore, after the configuration of the PHY layer block, the PHY layer block may transfer data included in the signal received from the counterpart communication node to the controller.

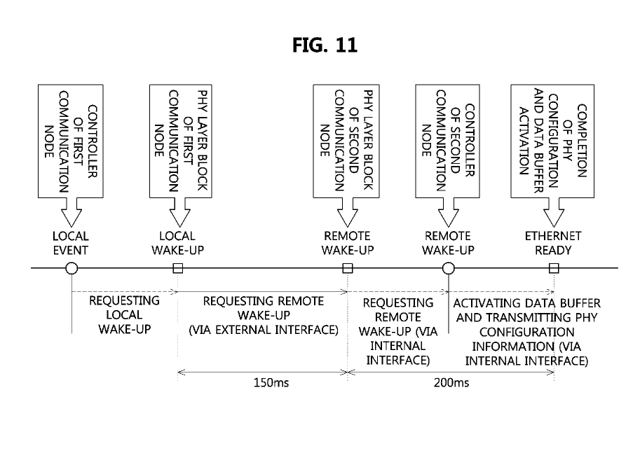

FIG. 11 is a timing diagram to explain an operation method of a communication node according to embodiments of the present disclosure.

As shown in FIG. 11, when a local event occurs, the controller of the first communication node may request a local wakeup to the PHY layer block of the first communication node according to the event. Then, the PHY layer block of the first communication node may transmit a wakeup signal to the PHY layer block of the second communication node which is connected with the first communication node via a predetermined network (e.g., external interface existing between communication nodes). Then, the PHY layer block of the second communication node may transfer the wakeup signal to the controller of the second communication node via a predetermined interface (e.g., internal interface existing between the controller and the PHY layer block). Accordingly, the controller of the second communication node may perform a partial booting (activation) operation for a portion of an OS which is used for data reception. Then, the controller of the second communication node may transmit configuration information for the PHY layer block to the PHY layer block of the second communication node. Then, the PHY layer block of the second communication node may transfer data received from the first communication node to the controller of the second communication node. Then, the controller of the second communication node may store the received data in a buffer activated according to the partial booting operation. Then, the controller of the second communication node may transfer the data stored in the buffer to the main memory, and perform operations indicated by the event. According to FIG. 11, the second communication node may receive the data transmitted by the first communication node without loss within 200 ms after receiving the wakeup signal.

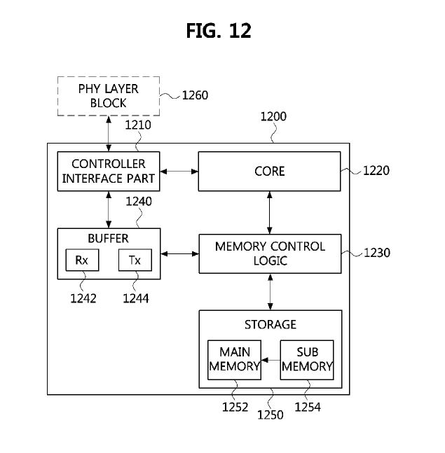

FIG. 12 is a block diagram to explain a controller according to embodiments of the present disclosure. The controller 1200 may include a controller interface part 1210, a core 1220, a memory control logic 1230, a buffer 1240, and a storage 1250.

The controller interface part 1210 may receive a wakeup signal for waking up the controller 1200 from the PHY layer block 1260. The controller interface part 1210 may receive the wakeup signal from the PHY layer block 1260 through a predetermined interface. Here, the predetermined interface may include MII, RMII, GMII, RGMII, SGMII, or XGMII.

The core 1220 may perform a partial booting operation for a portion of an OS which is used for receiving data transmitted from the PHY layer block 1260. The core 1220 may activate a portion of the OS such as a network management kernel, a memory management kernel, etc. which are used for data reception. Through activation of the device network management kernel and the memory management kernel, the core 1220 may control the memory control logic 1230 to preferentially activate the buffer 1240 used for reception of data transmitted by the PHY layer block 1260.

The memory control logic 1230 may control the data transmitted from the PHY layer block 1260 to be stored in the buffer 1240 according to control of the core 1220. That is, the memory control logic 1230 may preferentially active the buffer for data reception (e.g., RX buffer) according to the partial booting operation.

The buffer 1240 is a memory space for data transmission/reception performed with the PHY layer block 1260. For this, the buffer 1240 may include a reception buffer (RX buffer) 1242 and a transmission buffer (TX buffer) 1244. Such the buffer 1240 may be constructed as an independent module, or a predetermined memory sector in the main memory 1252 may be allocated as a memory space for the buffer. Also, the buffer 1240 may be included in the controller interface part 1210. Although the buffer 1240 and the main memory 1252 are illustrated as separate components, various exemplary embodiments are not restricted thereto.

In FIG. 12, the buffer 1240 is illustrated as an independent module. Especially, the buffer 1240 may store data transmitted from the PHY layer block 1260. That is, the buffer 1240 may temporarily store data transmitted from the PHY layer block 1260 in the RX buffer 1242 before or at the time of completion of the booting operation of the OS, according to control of the memory control logic 1230. Also, the buffer 1240 may output the data stored in the RX buffer 1242 to the main memory 1252 of the storage 1250 according to control of the memory control logic 1230.

The storage 1250 may store data or output the stored data under control of the memory control logic 1230. Especially, the storage 1250 may store data for the booting operation of the OS and data transmitted from the PHY layer block 1260 according to the partial activation of the OS. For this, the storage 1250 may be configured to include a main memory 1252 and a sub memory 1254. The main memory may correspond to a RAM which is a volatile memory that temporarily stores data for operations of the core 1220. Meanwhile, the sub memory 1253 may correspond to a non-volatile memory that stores OS codes (e.g., kernels and device-drivers) and application program codes for implementing controller functions.

The core 1220 may transmit configuration information for the PHY layer block to the PHY layer block 1260. The configuration information for the PHY layer block may be information used for configuring operations of the PHY layer block 1260 and interface between the controller 1200 and the PHY layer block 1260. According to control of the core 1220, the controller interface part 1210 may transmit the configuration information of the PHY layer block to the PHY layer block 1260.

The PHY layer block 1260 may use the configuration information transmitted from the controller 1200 to configure its PHY layer. After then, the PHY layer block 1260 may transmit data transmitted from a counterpart communication node to the controller 1200. Accordingly, the controller interface part 1210 of the controller 1200 may receive data transmitted from the PHY layer block 1260. Then, the received data may be stored in the RX buffer 1242 under control of the core 1220 and the memory control logic 1230. Here, the core 1220 may perform the operation of storing the data in the RX buffer 1242 and the remaining booting operation beyond the partial booting operation in a parallel manner. For the remaining booting operation, the kernel for booting operation may be loaded and decompressed, and the remaining booting operation may be performed using the kernel.

The core 1220 may control the memory control logic 1230 to transfer the data stored in the RX buffer 1242 to the main memory 1252. Accordingly, the memory control logic 1230 may transfer the data stored in the RX buffer 1242 to the main memory 1252 in a sequential manner (e.g., First-Input First-Output (FIFO) manner). Here, the core 1220 may perform the operation of transferring the data to the main memory 1252 and the remaining booting operation in a parallel manner. That is, while performing the remaining booting operation after the partial booting operation, the data stored in the RX buffer 1242 may be transferred to the main memory 1252.

Alternatively, the core 1220 may also transfer the data to the main memory 1252 after completion of the remaining booting operation. The core 1220 may determine whether the remaining booting operation is completed or not. If the remaining booting operation is completed, the core 1220 may control the memory control logic 1230 to transfer the data stored in the RX buffer 1242 to the main memory 1252. Accordingly, the memory control logic 1230 may transfer the data stored in the RX buffer 1242 to the main memory 1252. After then, the core 1220 may perform indicated operations by using the data stored in the main memory 1252.

On the other hand, if the RX buffer corresponds to a memory sector of the main memory and the received data are already stored in the memory sector of the main memory, since the received data are already stored in the main memory, the core 1220 may omit the step of transferring the data stored in the memory sector to the main memory.

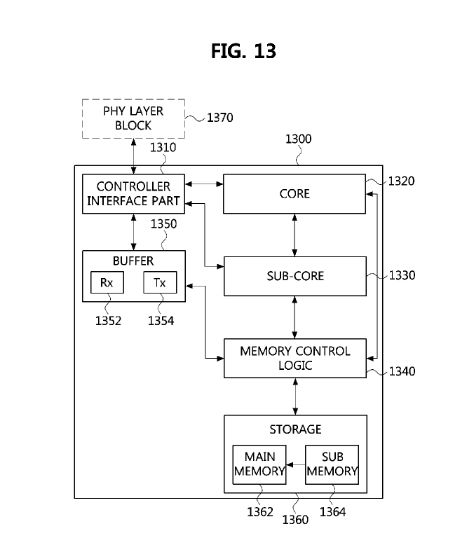

FIG. 13 is a block diagram to explain an additional controller according to embodiments of the present disclosure. The controller 1300 may include a controller interface part 1310, a core 1320, a sub-core 1330, a memory control logic 1340, a buffer 1350, and a storage 1360.

The controller interface part 1310 may receive a wakeup signal for waking up the controller 1300 from the PHY layer block 1370. The controller interface part 1310 may receive the wakeup signal from the PHY layer block 1370 through a predetermined interface. The predetermined interface may include MII, RMII, GMII, RGMII, SGMII, or XGMII.

In response to the wakeup signal, the core 1320 may perform a booting operation of an OS. Especially, the core 1320 may perform the remaining booting operation except the partial booting operation performed by the sub-core 1330 which will be explained later. For the remaining booting operation, the core 1320 may load OS kernel, decompress the OS kernel, and perform the remaining booting operation by using the OS kernel.

The sub-core 1330 may activate a portion of the OS for receiving data to be transmitted by the PHY layer block 1370 through the partial booting operation. For example, the sub-core 1330 may activate a portion of the OS which is related to the data reception, such as a network management kernel or a memory management kernel. Through the activation of the device memory network management kernel and the memory management kernel, the sub-core 1330 may control the memory control logic 1340 to activate the buffer 1350 for storing data to be transmitted by the PHY layer block 1370.

According to control of the sub-core 1330, the memory control logic 1340 may control the buffer 1350 to store the data transmitted from the PHY layer block 1370. That is, through the partial booting operation, the memory control logic 1340 may preferentially activate the buffer 1350 which exists in the controller interface part 1310 or exists as an independent module.

The buffer 1350 is a memory for data transmission and reception with the PHY layer block 1370. For this, the buffer 1350 may include a reception (RX) buffer 1352 and a transmission (TX) buffer 1354. The buffer 1350 may be constructed as an independent module, or be allocated in a predetermined memory sector of the main memory 1362 as a buffer region. Also, the buffer 1350 may also be included in the controller interface part 1310. However, although the buffer 1350 and the main memory 1362 are illustrated as independent components in FIG. 13, embodiments according to the present disclosure are not restricted thereto.

In FIG. 13, the buffer 1350 is illustrated as an independent module. Especially, the buffer 1350 may store data transmitted by the PHY layer block 1370. That is, the buffer 1350 may temporarily store the data transmitted from the PHY layer block 1370 before or at the time of completion of the booting operation according to control of the memory control logic 1340. Also, the buffer 1350 may output the data stored in the RX buffer 1352 to the main memory 1362 of the storage 1360 according to control of the memory control logic 1340.

The storage 1360 may store data or output the stored data according to control of the memory control logic 1340. Especially, the storage 1360 may store data for the booting operation of the OS, and store the data transmitted by the PHY layer block 1370 according to the partial booting operation. For this, the storage 1360 may be configured to include the main memory 1362 and the sub memory 1364.

The sub-core 1330 may transmit configuration information for the PHY layer block to the PHY layer block 1370. The configuration information for the PHY layer block is information for configuring operations of the PHY layer block 1370 and interfacing operations between the controller 1300 and the PHY layer block 1370. According to control of the sub-core 1330, the controller interface part 1310 may transfer the configuration information to the PHY layer block 1370.

The PHY layer block 1370 may configure its PHY layer block by using the configuration information transmitted from the controller 1300. Then, the PHY layer block 1370 may transfer data received from a counterpart communication node to the controller 1300. Accordingly, the controller interface part 1310 of the controller 1300 may receive the data transmitted from the PHY layer block 1370. Then, the received data may be stored in the RX buffer 1352 according to control of the sub-core 1330 and the memory control logic 1340. In this instance, the remaining booting operation performed by the core 1320 and the operation of storing the data in the RX buffer 1352 performed by the sub-core 1330 may be performed in a parallel manner.

Then, the sub-core 1330 may control the memory control logic 1340 to transfer the data stored in the RX buffer 1352 to the main memory 1362. Accordingly, the memory control logic 1340 may transfer the data stored in the RX buffer 1352 to the main memory 1362 in a sequential manner (e.g., FIFO). Here, the operation of transferring the data stored in the RX buffer 1352 to the main memory 1362, performed by the sub-core 1330, and the remaining booting operation performed by the core 1320 may be performed in a parallel manner. That is, while the core 1320 performs the remaining booting operation, the data stored in the RX buffer 1352 may be transferred to the main memory 1362.

Meanwhile, after completion of the remaining booting operation, the core 1320 may transfer the data stored in the RX buffer 1352 to the main memory 1362. The core 1320 may determine whether the remaining booting operation is completed. If the remaining booting operation is completed, the role of the sub-core 1330 may not be further necessary. Accordingly, the control functions of the sub-core 1330 may be transferred to the core 1320. Therefore, after completion of the remaining booting operation, the core 1320 may control the memory control logic 1340 to transfer the data stored in the RX buffer 1352 to the main memory 1362, instead of the sub-core 1330. Accordingly, the memory control logic 1340 may transfer the data stored in the RX buffer 1352 to the main memory 1362. Then, the core 1320 may perform operations by using the data stored in the main memory 1362.

Meanwhile, if the RX buffer is allocated in the main memory and the received data are stored in the allocated region of the main memory, since the received data are already stored in the main memory, the step of transferring the data stored in the RX buffer to the main memory, performed by the core 1320 or the sub-core 1330, may be omitted.

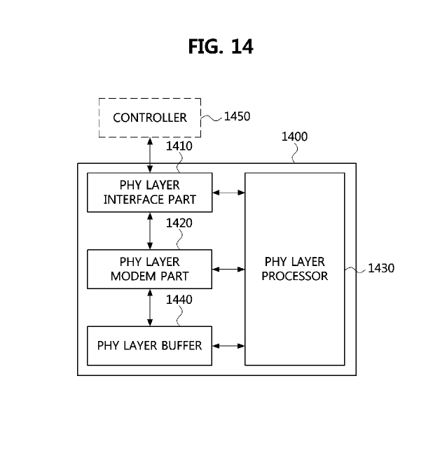

FIG. 14 is a block diagram to explain a PHY layer block according to embodiments of the present disclosure. The PHY layer block may include a PHY interface part 1410, a PHY layer modulation/demodulation (modem) part 1420, a PHY layer processor 1430, and a PHY layer buffer 1440.

The PHY layer interface part 1410 may receive a signal transmitted by a counterpart communication node. The signal which the PHY layer interface part 1410 receives from the counterpart communication node may include a wakeup signal and/or data signal.

The PHY layer interface part 1410 may be connected to the counterpart communication node via a predetermined network to receive the signal from the counterpart communication node. Here, the predetermined network may be a CAN network, a FlexRay network, a MOST network, a LIN network, or an Ethernet network. The predetermined network may be connected in a topology such as a star topology, a bus topology, a ring topology, a tree topology, a mesh topology, etc. Also, the PHY layer interface part 1410 may communicate with the counterpart communication node by using a CAN protocol, a FlexRay protocol, a MOST protocol, a LIN protocol, or an Ethernet protocol.

The PHY layer interface part 1410 may identify whether a signal exists in a channel through an energy detection operation. That is, when a signal having a strength greater than a predetermined threshold is detected in the channel through the energy detection operation, the PHY layer interface part 1410 may determine that the signal exists in the channel.

The PHY layer interface part 1410 may transmit the received signal to the PHY layer modem part 1420, and inform the PHY layer processor 1430 of that the signal exists in the channel. Alternatively, the PHY layer interface part 1410 may transmit the received signal to the PHY layer processor 1430, and the PHY layer processor 1430 may determine that the signal exists in the channel when the signal is received from the PHY layer interface part 1410, and transfer the signal received from the PHY layer interface part 1410 to the PHY layer modem part 1420.

Also, the PHY layer interface part 1410 may transmit a wakeup signal to the controller 1450 in order to wake up the controller 1450. Here, the PHY layer interface part 1410 may transmit the wakeup signal to the controller via a predetermined interface. Such the predetermined interface may be MII, RMII, GMII, RGMII, SGMII, or XGMII.

Also, the PHY layer interface part 1410 may receive configuration information for the PHY layer block 1400 from the controller 1450. The configuration information may include information for configuring operations of the PHY layer block 1400 and an interface between the controller 1450 and the PHY layer block 1400.

After receiving the signal from the controller 1450, the PHY layer modem part 1420 may perform modulation on the received signal, and transfer the modulated signal to at least one of the PHY layer interface part 1410, the PHY layer processor 1430, and the PHY layer buffer 1440. Also, if the PHY layer modem part 1420 receives the signal from the PHY layer interface part 1410 or the PHY layer processor 1430, the PHY layer modem part 1420 may perform demodulation on data included in the received signal, and transfer the demodulated data to at least one of the PHY layer processor 1430 and the PHY layer buffer 1440.

The PHY layer processor 1430 may control respective operations of the PHY layer interface part 1410, the PHY layer modem part 1420, and the PHY layer buffer 1440. The PHY layer processor 1430 may generate or extract the wakeup signal for waking up the controller 1450 based on the received signal, and control the PHY layer interface part 1410 to transmit the wakeup signal to the controller 1450. Accordingly, the PHY layer interface part 1410 may transmit the wakeup signal to the controller 1450 via the predetermined interface.

Also, the PHY layer processor 1430 may control the PHY layer buffer 1440 to store data included in the received signal. For this, once the PHY layer processor 1430 receives the signal from the counterpart communication node, the PHY layer processor 1430 may control the PHY layer modem part 1420 to demodulate the data included in the received signal. Accordingly, the data demodulated in the PHY layer modem part 1420 may be transferred to the PHY layer buffer 1440.

Also, the PHY layer processor 1430 may configure its PHY layer by using the configuration information for the PHY layer block 1400. The PHY layer processor 1430 may perform configuration of operations of the PHY layer and configuration for the interface between the PHY layer block 1400 with the controller 1450.

After configuring the PHY layer, the PHY layer processor 1430 may control the data stored in the PHY layer buffer 1440 to be transmitted to the controller 1450. Accordingly, the PHY layer interface part 1410 may transmit the data stored in the PHY layer buffer 1440 to the controller 1450 according to control of the PHY layer processor 1430. Accordingly, the controller 1450 may store the data transmitted from the PHY layer block 1400 in the RX buffer or the main memory of the controller 1450.

The PHY layer buffer 1440 may store the data transmitted from the counterpart communication node. When the PHY layer buffer 1440 is instructed by the PHY layer processor 1430 to store the data or receives the data from the PHY layer modem part 1420, the PHY layer buffer 1440 may store the received data. Also, the PHY layer buffer 1440 may output the stored data according to request of the PHY layer 1430.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software. Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail, it should be understood that various changes, substitutions and alterations may be made herein without departing from the scope of the disclosure.

What is claimed is:

1. An operation method of a communication node including a physical (PHY) layer block and a controller, the method comprising:
receiving, by the controller, a wakeup signal for waking up the controller from the PHY layer block;
performing, by the controller, a partial booting operation for a first portion of an operating system (OS) which is required to receive data transmitted by the PHY layer block;
receiving, by the controller, data transmitted by the PHY layer block; and
storing, by the controller, the received data in a buffer activated according to the partial booting operation.

2. The operation method according to claim 1, further comprising receiving, by the controller, the wakeup signal via at least one of: a media independent interface (MII), a reduced MII (RMII), a gigabit MII (GMII), a reduced GMII (RGMII), a serial GMII (SGMII), and a 10 GMII (XGMII).

3. The operation method according to claim 1, wherein the first portion of the OS includes at least one of a network management kernel and a memory management kernel.

4. The operation method according to claim 1, wherein the buffer that is activated according to the partial booting operation is a reception (RX) buffer.

5. The operation method according to claim 1, further comprising transmitting, by the controller, configuration information for the PHY layer block to the PHY layer block.

6. The operation method according to claim 1, further comprising transferring, by the controller, the data stored in the buffer to a main memory of the controller.

7. The operation method according to claim 6, wherein the transferring of the data stored in the buffer to the main memory of the controller comprises:
performing, by the controller, a remaining booting operation for a second portion of the OS; and
transferring, by the controller, the data stored in the buffer to the main memory of the controller after completion of the remaining booting operation.

8. The operation method according to claim 7, wherein the controller performs the remaining booting operation and stores the data in the buffer in a parallel processing manner.

9. The operation method according to claim 1, wherein the communication node is connected to an automotive network.

10. An operation method of a communication node including a physical (PHY) layer block and a controller, the method comprising:
receiving, by the controller, a wakeup signal for waking up the controller from the PHY layer block;
performing, by a sub-core of the controller, a partial booting operation for a first portion of an operating system (OS) which is required to receive data transmitted by the PHY layer block;
receiving, by the sub-core of the controller, data transmitted by the PHY layer block; and
storing, by the sub-core of the controller, the received data in a buffer activated according to the partial booting operation.

11. The operation method according to claim 10, wherein the buffer that is activated according to the partial booting operation is a reception (RX) buffer.

12. The operation method according to claim 10, further comprising transferring, by the sub-core of the controller, the data stored in the buffer to a main memory of the controller.

13. The operation method according to claim 12, wherein the transferring of the data stored in the buffer to the main memory of the controller comprises:
performing, by a core of the controller, a remaining booting operation for a second portion of the OS; and
transferring, by the core of the controller, the data stored in the buffer to the main memory of the controller after completion of the remaining booting operation.

14. The operation method according to claim 13, wherein the remaining booting operation and the storing of the data in the buffer are performed by the core of the controller and the sub-core of the controller, respectively, in a parallel processing manner.

15. The operation method according to claim 10, wherein the communication node is connected to an automotive network.

16. An operation method of a communication node including a physical (PHY) layer block and a controller, the method comprising:
receiving, by the PHY layer block, a signal transmitted by a counterpart communication node;
transmitting, by the PHY layer block, a wakeup signal for waking up the controller to the controller;
receiving, by the PHY layer block, configuration information for the PHY layer block from the controller;
configuring, by the PHY layer block, a PHY layer using the received configuration information; and
transmitting, by the PHY layer block, data included in the received signal to the controller.

17. The operation method according to claim 16, wherein the communication node is connected to an automotive network.

18. A controller of a communication node including a physical (PHY) layer block, the controller comprising:
a controller interface part receiving a wakeup signal for waking up the controller from the PHY layer block and data transmitted by the PHY layer block;
a core performing a partial booting operation for a first portion of an operating system (OS) which is required to receive the data transmitted by the PHY layer block;
a buffer storing the received data transmitted by the PHY layer block; and
a memory control logic controlling the buffer to store the received data.

19. The controller according to claim 18, wherein the core controls the controller interface part to transmit configuration information to the PHY layer block and controls the buffer to store the data received from the PHY layer block.

20. The controller according to claim 18, wherein the core performs a remaining booting operation for a second portion of the OS and transfers the data stored in the buffer to a main memory of the controller after completion of the remaining booting operation.

21. The controller according to claim 20, wherein the core performs the remaining booting operation and stores the data in the buffer in a parallel processing manner.

22. A controller of a communication node including a physical (PHY) layer block, the controller comprising:
a controller interface part receiving a wakeup signal for waking up the controller from the PHY layer block and data transmitted by the PHY layer block;
a sub-core performing a partial booting operation for a first portion of an operating system (OS) which is required to receive the data transmitted by the PHY layer block;
a buffer storing the received data transmitted by the PHY layer block;
a memory control logic controlling the buffer to store the data; and
a core performing a remaining booting operation for a second portion of the OS and transferring the data stored in the buffer to a main memory of the controller after completion of the remaining booting operation.

23. The controller according to claim 22, wherein the remaining booting operation and the storing of the data in the buffer are performed by the core and the sub-core, respectively, in a parallel processing manner.

24. A physical (PHY) layer block of a communication node including a controller, the PHY layer block comprising:
a PHY layer interface part receiving a signal transmitted by a counterpart communication node and receiving configuration information for the PHY layer block from the controller;
a PHY layer processor causing a wakeup signal for waking up the controller to be transmitted to the controller and configuring the PHY layer block using the configuration information; and
a PHY layer buffer storing data included in the signal received from the counterpart communication node.
